(19) United States
(12) Patent Application Publication
(10) Pub. No.: US 2024/0409029 A1
(43) Pub. Date: Dec. 12, 2024

(54) VEHICLE MIRROR LOCKING AND RELEASE ASSEMBLY

(71) Applicant: Michael Ferman, New South Wales (AU)

(72) Inventor: Michael Ferman, New South Wales (AU)

(21) Appl. No.: 18/699,236

(22) PCT Filed: Oct. 6, 2022
(86) PCT No.: PCT/AU2022/051197

§ 371 Date: Apr. 5, 2024

(30) Foreign Application Priority Data
Oct. 6, 2021 (AU) 2021903194

(51) Int. Cl. B60R 1/06

(52) U.S. Cl. CPC B60R 1/0605

(57) ABSTRACT

An external vehicle rear view mirror assembly has a mirror (12), a mirror plate (14), and a mirror retention plate (16). The mirror plate has an attachment arrangement which can releasably engage the mirror plate to the mirror retention plate. The attachment arrangement has a locking assembly for engaging the mirror retention plate so that the mirror plate, when in the engaged position, can assume a locked position with respect to the mirror retention plate. The locking assembly has locking pins (24, 26) which are movable between a locking position and an unlocking position. Each locking pin has a leading free end (28) and an opposite head end (30). The head end has pin locking surfaces (32, 33a, 33b) which are engageable with a respective plate locking surface (34) of the mirror plate by operation of a respective spring loaded clip-on mechanism (36). Each locking pin is in the locking position when the leading free ends engage the mirror retention plate and lockably retain the mirror plate in the locked position. Each locking pin is in the unlocking position when the leading free ends are disengaged from the mirror retention plate after releasing the spring loaded clip-on mechanism.

### TECHNICAL FIELD

The present invention relates to external vehicle rear view mirror assemblies, especially of the type used on trucks. In particular, the invention relates to a locking and release assembly for a mirror plate in such mirror assemblies.

### BACKGROUND ART

U.S. Pat. No. 5,355,255 discloses a vehicle mirror assembly in which a mirror is attached by a spherical socket formation to a mirror plate which is retained within a mirror housing. The mirror plate is not directly engaged to any mirror retaining plate and cannot be moved from any engaged position to any disengaged position with respect to any such retaining plate.

U.S. Pat. No. 5,615,054 discloses a vehicle mirror assembly in which a mirror is attached to a mirror plate which, in turn, is attached by a sliding engagement to a mirror retaining plate in a mirror housing. Complementary projections are provided on two parallel sides of the mirror plate and the mirror retaining plate so that the mirror plate can be slid into a retention position. This arrangement allows for replacement of the mirror plate (and its attached mirror) if the mirror is broken or damaged.

U.S. Pat. Nos. 6,325,519, 6,328,451 and 63,735,333 disclose alternative vehicle mirror arrangements which use a sliding engagement.

None of the above arrangements provide any means to lock a mirror plate directly to a mirror retaining plate. Nor do they disclose any release mechanism which can actuate any locking mechanism from such a locked position to an engaged position, where a mirror plate is engaged, but not yet locked, to a mirror retaining plate.

U.S. Pat. No. 9,539,946, to the present inventor, does disclose various means for locking a mirror plate directly to a mirror retention plate, and also discloses various release mechanisms which actuate a locking mechanism from a locked position of the mirror plate to an attach (or engaged) position of the mirror plate with respect to a mirror retention plate.

However, the various arrangements of mirror plate locking and release mechanisms disclosed in U.S. Pat. No. 9,539,946, whilst effective, are complex and costly to manufacture and repair. Those arrangements include rotatable locking and release components, such as a rotatable shaft which incorporates levers, coil springs, slidable and rotatable levers, a rotatable worm assembly, and a gear wheel, all of which are prone to being damaged in the range of conditions experienced by the vehicles upon which such mirror assemblies are mounted.

Therefore, it is a motivation of the present inventor, and an object of this invention, to overcome, or at least substantially ameliorate, the aforementioned shortcomings of the prior art and to provide an external vehicle rear view mirror assembly, and specifically a locking and release assembly for a mirror plate in such a mirror assembly, which provides for both easy locking and easy releasing of the mirror plate, so as to facilitate easy replacement of the mirror plate when required.

It is a preferred object of this invention to provide a locking assembly for a mirror plate in such mirror assemblies which can securely and reliably lock the mirror plate in its operational position and which can then be easily released by simple “press down and lever out” actions of a user utilizing a screwdriver or the like.

### DISCLOSURE OF INVENTION

According to the present invention, there is provided an external vehicle rear view mirror assembly, comprising: a mirror, a mirror plate having a first surface to which the mirror is attached and a second surface being opposite to the first surface, the second surface having an attachment arrangement for releasably engaging the mirror plate to a mirror retention plate, the mirror retention plate having a first edge and a second edge, the attachment arrangement comprising one or more projections of the mirror plate for engaging the first edge of the mirror retention plate so that the mirror plate can assume an engaged position with respect to the mirror retention plate, and a locking assembly for engaging the second edge of the mirror retention plate so that the mirror plate, when in the engaged position, can assume a locked position with respect to the mirror retention plate, the locking assembly comprising at least one slidable locking pin movable between a locking position and an unlocking position, the or each locking pin having a leading free end and an opposite head end, the head end having at least one pin locking surface which is engageable with a plate locking surface of the mirror plate by operation of a spring loaded clip-on mechanism, wherein, when the or each locking pin is in the locking position, the leading free end of the or each locking pin has engaged the second edge of the mirror retention plate and lockably retained the mirror plate in the locked position, and when the or each locking pin is in the unlocking position, the leading free end of the or each locking pin has disengaged from the second edge of the mirror retention plate after releasing the spring loaded clip-on mechanism.

Preferably, there are two locking pins in the mirror assembly.

In a preferred form, the spring loaded clip-on mechanism is located at the head end of the or each locking pin.

Preferably, the head end of the or each locking pin has three pin locking surfaces, although there may alternatively be one or more pin locking surfaces, which are engageable with a respective plate locking surface of the mirror plate by operation of the spring loaded clip-on mechanism.

In a preferred form, the plate locking surface of the mirror plate is an inner surface of a locking wall located internally of, and extending partly across, an opening in a side wall of the mirror plate.

It is also preferred that the mirror retention plate is connected to an electric motorized actuator for adjusting the angular position of the mirror.

The first and second edges of the mirror retention plate are preferably parallel to each other, and may also be opposite to each other.

In another preferred form, there are two projections for engaging the first edge of the mirror retention plate.

In a preferred form, the leading free end of the or each locking pin is configured to be inserted through the opening in the side wall of the mirror plate and then through aligned openings defined by internal bridges formed on the mirror plate.

It is preferred that the leading free end of the or each locking pin can penetrate only as far as an overlapping location with the second edge of the mirror retention plate, before the locking pin is prevented from further penetration by one or more structural elements of the head end abutting against one or more walls of the mirror plate.

With the leading free end at that overlapping location, the most outwardly located end wall of the head end of the or each locking pin is preferably at a location where it is aligned with the side wall of the mirror plate.

Preferably, the head end of the or each locking pin includes an inner pin locking surface and a pair of outer pin locking surfaces at respective opposite sides of the head end.

The outer pin locking surfaces are preferably the elevated end face surfaces of side ramped structures which are formed at opposite sides of the head end of the or each locking pin.

The opposite sides of the head end are preferably separated by a gap and are preferably flexible, and are preferably interconnected by an end wall.

The inner pin locking surface is preferably the elevated end face surface of a central ramped structure which is formed on a flexible tongue portion of the head end of the or each locking pin.

The tongue portion preferably extends into the gap separating the opposite sides of the head end.

It is also preferred that the tongue portion has a connecting end at which it is connected to a main body of the or each locking pin, and has a free end at which a receptacle is located.

Preferably, the central ramped structure is located intermediate the connecting end of the tongue portion and the receptacle.

The inner pin locking surface of the central ramped structure of the tongue portion is preferably located further from the end wall than are the outer pin locking surfaces of the side ramped structures at the opposite sides of the head end.

It is also preferred that the height of the inner pin locking surface of the central ramped structure is greater than the height of the outer pin locking surfaces of the side ramped structures.

The spring loaded clip-on mechanism preferably comprises outer pin locking surfaces of flexible opposite sides at the head end of the or each locking pin, an inner pin locking surface of a flexible tongue portion at the head end of the or each locking pin, and respective plate locking surfaces of the mirror plate and against which the outer and inner pin locking surfaces can be engaged.

In an alternative form of the invention, which represents a reversal of the structural arrangement of the above mentioned spring loaded clip-on mechanism, the spring loaded clip-on mechanism instead comprises a plate locking surface of a flexible tongue portion of the mirror plate, and a pin locking surface at the head end of the locking pin and against which the plate locking surface can be engaged.

A more particular embodiment, which is also a reversal of the structural arrangement of the earlier mentioned spring loaded clip-on mechanism, may comprise outer plate locking surfaces of flexible opposite sides of a part of the mirror plate, an inner plate locking surface of a flexible tongue portion of the same part of the mirror plate, and respective pin locking surfaces at the head end of the or each locking pin and against which the outer and inner plate locking surfaces can be engaged.

There has been thus outlined, rather broadly, the more important features of the invention in order that the detailed description thereof that follows may be better understood and put into practical effect, and in order that the present contribution to the art may be better appreciated.

There are additional features of the invention that will be described hereinafter. As such, those skilled in the art will appreciate that the conception, upon which the disclosure is based, may be readily utilized as the basis for designing other structures, assemblies, process steps and system configurations for carrying out the object of the present invention. It is important, therefore, that the broad outline of the invention described above be regarded as including such equivalent features insofar as they do not depart from the spirit and scope of the present invention.

### SUMMARY OF THE DRAWINGS

FIG. 1 is a front perspective view of an external vehicle rear view mirror assembly according to a preferred embodiment of the invention mounted to a mirror bracket of a truck.

FIG. 2 is a rear perspective view of the mirror assembly of FIG. 1.

FIG. 3 is a sectional side view of the mirror assembly of FIGS. 1 and 2.

FIG. 4 is a view similar to that of FIG. 3 but showing the top mirror assembly of the mounted mirror assembly of FIGS. 1 to 3 in an angularly adjusted position.

FIG. 5 is a front perspective view of an isolated top mirror assembly of the mounted mirror assembly of FIGS. 1 to 4, the top mirror assembly being formed of an interconnected mirror, mirror plate, mirror retention plate, and a pair of locking pins.

FIG. 6 is a rear perspective view of the top mirror assembly of FIG. 5.

FIG. 7 is a front perspective view of a preferred embodiment of a locking pin for use in the mounted mirror assembly of FIGS. 1 to 4 and in the top mirror assembly of FIGS. 5 and 6.

FIG. 8 is a side view of the locking pin of FIG. 7.

FIG. 9 is a front view of the locking pin of FIG. 7.

FIG. 10 is an exploded view of the components forming the top mirror assembly shown in FIG. 6.

FIG. 11 is an underside perspective view of the top mirror assembly of FIG. 6.

FIG. 12 is an enlarged partial end view of the top mirror assembly of FIG. 11 showing a first step of an unlocking process in which the locking pins are to be moved from a locking position, where the locking pins lockably retain the mirror plate in the locked position with respect to the mirror retention plate, to an unlocking position, where the mirror plate can be disengaged from the mirror retention plate.

FIG. 13 is a sectional partial side view of the top mirror assembly of FIG. 12 showing the first step of the unlocking process from a different angle.

FIG. 14 is a view similar to that of FIG. 13 but now showing a second step in the unlocking process.

FIG. 15 is a view similar to that of FIG. 14 but now showing a third step in the unlocking process.

FIG. 16 is a view similar to that of FIG. 15 but now showing a fourth step in the unlocking process.

FIG. 17 is a view similar to that of FIG. 16 but now showing a fifth step in the unlocking process.

FIG. 18 is a view similar to that of FIG. 17 but now showing a sixth step in the unlocking process.

FIG. 19 is a view similar to that of FIG. 18 but now showing a seventh step in the unlocking process.

FIG. 20 is a view similar to that of FIG. 19 but now showing a final step in the unlocking process.

FIG. 21 is a view similar to that of FIG. 20 but now showing the mirror retention plate fully disengaged from the mirror plate.

FIG. 22 is a is a front perspective view of another preferred embodiment of a locking pin for use in a mounted mirror assembly of FIGS. 1 to 4 and in the top mirror assembly of FIGS. 5 and 6.

FIG. 23 is a side view of the locking pin of FIG. 22.

FIG. 24 is a front view of the locking pin of FIG. 22.

FIG. 25 is a view similar to that of FIG. 13 but showing a first step of an unlocking process in which a pair of locking pins according to FIGS. 22 to 24 are to be moved from a locking position to an unlocking position.

FIG. 26 is a view similar to that of FIG. 25 but now showing a second step in the unlocking process.

FIG. 27 is a view similar to that of FIG. 26 but now showing a third step in the unlocking process.

FIG. 28 is a view similar to that of FIG. 27 but now showing a fourth step in the unlocking process.

FIG. 29 is a view similar to that of FIG. 28 but now showing a fifth step in the unlocking process.

FIG. 30 is a view similar to that of FIG. 29 but now showing the mirror retention plate fully disengaged from the mirror plate.

FIG. 31 is a front perspective view of an embodiment of a locking pin for use in an external vehicle rear view mirror assembly according to another preferred embodiment of the invention, the preferred embodiment being a reversal of the structural arrangement of the spring loaded clip-on mechanism illustrated and described with respect to FIGS. 1 to 30.

FIG. 32 is a rear view of the locking pin of FIG. 31.

FIG. 33 is a front view of the locking pin of FIG. 31.

FIG. 34 is a side view of the locking pin of FIG. 31.

FIG. 35 is an end view of the locking pin of FIG. 31.

FIG. 36 is a sectional partial side view of a top mirror assembly of an external vehicle rear view mirror assembly according to the aforementioned preferred embodiment of the invention in which the locking pin of FIGS. 31 to 35 is used.

FIG. 37 is a bottom end view of the top mirror assembly of FIG. 36 showing a first step of the unlocking process.

FIG. 38 is a sectional partial side view of the top mirror assembly of FIGS. 36 and 37 but now showing a second step in the unlocking process.

FIG. 39 is a view similar to that of FIG. 38 but now showing a third step in the unlocking process.

FIG. 40 is a view similar to that of FIG. 39 but now showing a fourth step in the unlocking process.

FIG. 41 is a view similar to that of FIG. 40 but now showing the locking pin disengaged from the top mirror assembly, whereby the mirror retention plate can then be fully disengaged from the mirror plate.

FIG. 42 is a sectional partial side view of a top mirror assembly of an external vehicle rear view mirror assembly according to another preferred embodiment of the invention in which a similar locking pin to that of FIGS. 31 to 35 is used.

FIG. 43 is a bottom end view of the top mirror assembly of FIG. 42 showing a first step of the unlocking process.

FIG. 44 is a sectional partial side view of the top mirror assembly of FIGS. 42 and 43 but now showing a second step in the unlocking process.

FIG. 45 is a view similar to that of FIG. 44 but now showing a third step in the unlocking process.

FIG. 46 is a view similar to that of FIG. 45 but now showing a fourth step in the unlocking process.

FIG. 47 is a view similar to that of FIG. 46 but now showing the locking pin disengaged from the top mirror assembly, whereby the mirror retention plate can then be fully disengaged from the mirror plate.

FIG. 48 is a sectional partial side view of a top mirror assembly of an external vehicle rear view mirror assembly according to another preferred embodiment of the invention in which a different locking pin (as shown fully in FIG. 55) is used.

FIG. 49 is a front view of the top mirror assembly of FIG. 48.

FIG. 50 is a view similar to that of FIG. 49 showing a first step of the unlocking process.

FIG. 51 is a view similar to that of FIG. 50 but now showing a second step in the unlocking process.

FIG. 52 is a view similar to that of FIG. 51 but now showing a third step in the unlocking process.

FIG. 53 is a view similar to that of FIG. 52 but now showing a fourth step in the unlocking process.

FIG. 54 is a view similar to that of FIG. 53 but now showing a fifth step in the unlocking process.

FIG. 55 is a view similar to that of FIG. 54 but now showing the locking pin disengaged from the top mirror assembly, whereby the mirror retention plate can then be fully disengaged from the mirror plate.

### DETAILED DESCRIPTION OF THE INVENTION

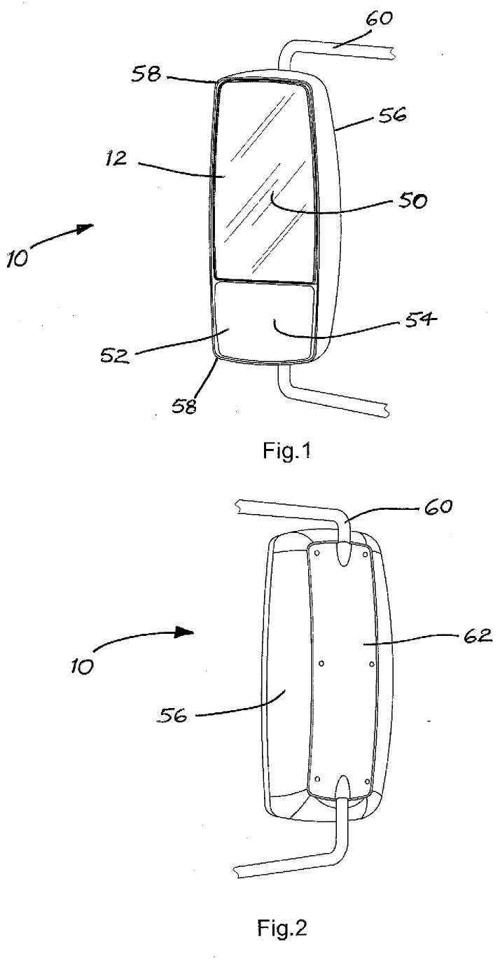

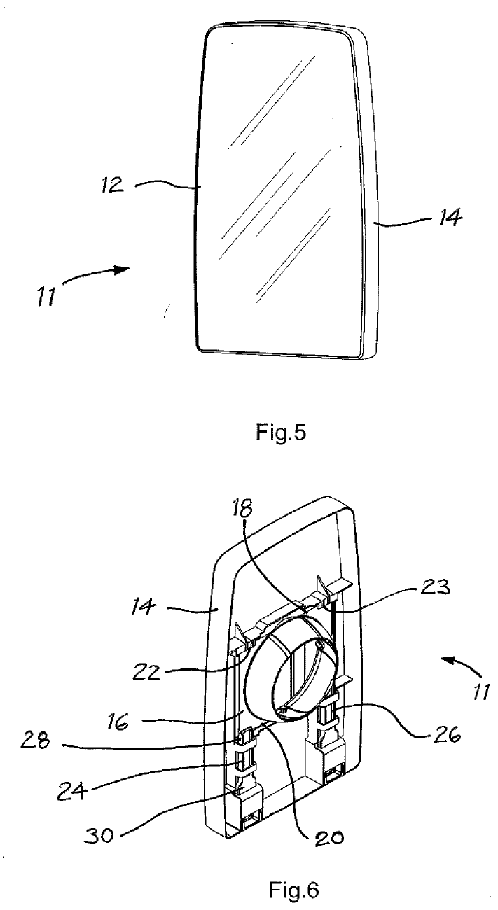

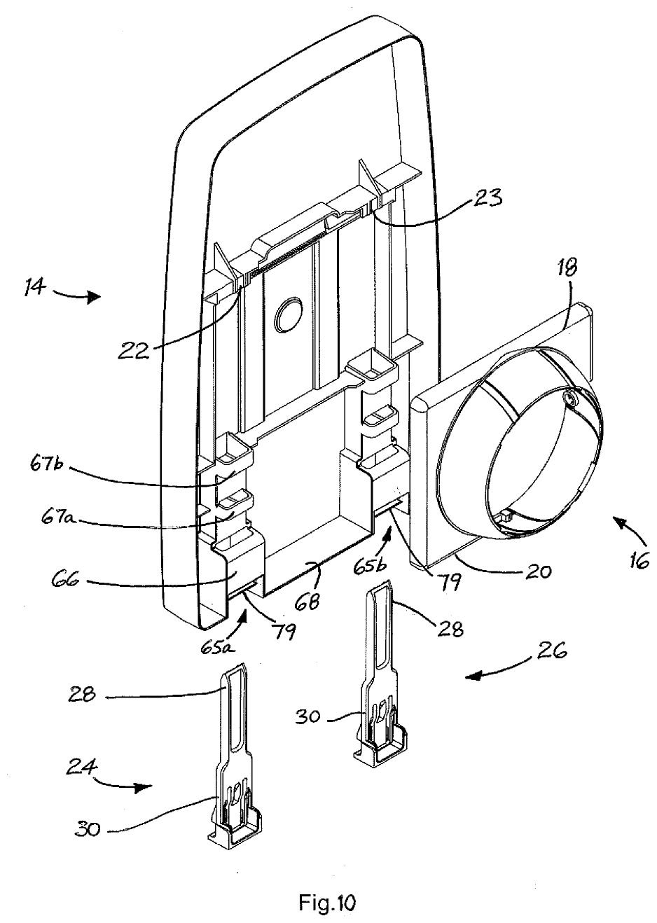

In a broad embodiment, the external vehicle rear view mirror assembly, shown in FIGS. 1 to 4 as a mounted mirror assembly 10 and shown in FIGS. 5 to 30 as a top mirror assembly 11 of the mounted mirror assembly 10, has a mirror 12, a mirror plate 14, and a mirror retention plate 16, and the mirror plate 14 has an attachment arrangement which can releasably engage the mirror plate 14 to the mirror retention plate 16. The mirror retention plate 16 has a first edge 18 and a second edge 20. The attachment arrangement has, in this embodiment, two projections 22, 23, although there may alternatively be one or more projections, for engaging the first edge 18 of the mirror retention plate 16 so that the mirror plate 14 can assume an engaged position with respect to the mirror retention plate 16.

The attachment arrangement also has a locking assembly for engaging the second edge 20 of the mirror retention plate 16 so that the mirror plate 14, when in the engaged position, can assume a locked position with respect to the mirror retention plate 16. The locking assembly has, in this embodiment, two locking pins 24, 26, although there may alternatively be one or more locking pins, which are movable between a locking position and an unlocking position.

Each locking pin 24, 26 has a leading free end 28 and an opposite head end 30. The head end 30 has, in this embodiment, three pin locking surfaces 32, 33a, 33b, although there may alternatively be one or more pin locking surfaces, which are engageable with a respective plate locking surface 34 of the mirror plate 14 by operation of a respective spring loaded clip-on mechanism 36.

Each locking pin 24, 26 is in the locking position when the leading free ends 28 engage the second edge 20 of the mirror retention plate 16 and lockably retain the mirror plate 14 in the locked position. Each locking pin 24, 26 is in the unlocking position when the leading free ends 28 are disengaged from the second edge 20 of the mirror retention plate 16 after releasing the spring loaded clip-on mechanism 36.

In a more particular embodiment, the mounted mirror assembly 10 shown in FIGS. 1 to 4 has a top mirror 12, which has a flat reflective outer surface 50, and a smaller bottom mirror 52, which has a convexly curved reflective outer surface 54. The mounted mirror assembly 10 has a housing 56 with a built-in chassis and an outer rim 58 surrounding both of the mirrors 12, 52. A mirror bracket 60 or other door mounted arm arrangement supports the mirror assembly 10 in its operational position on a truck or other vehicle. A vertical portion of the mirror bracket 60 is enclosed and secured between the rear of the housing 56 and a rear cover 62.

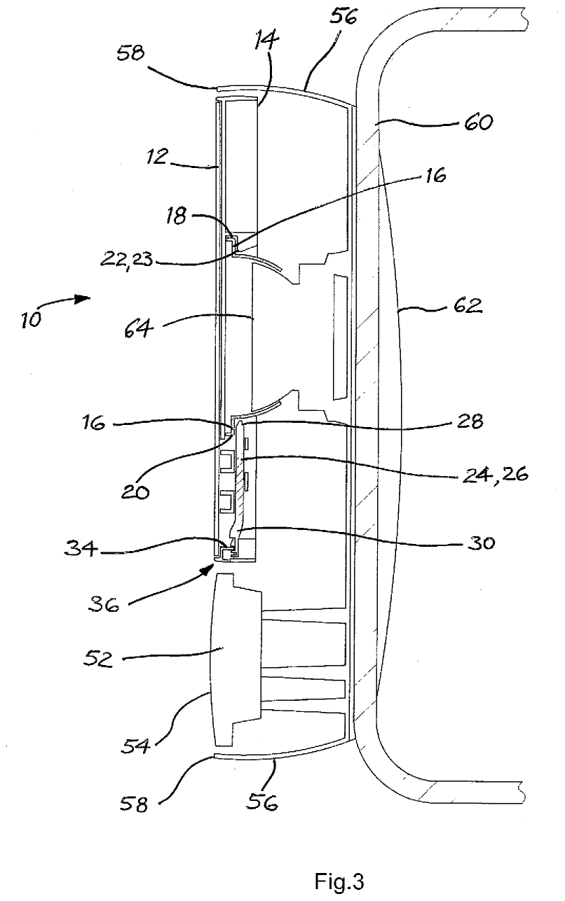

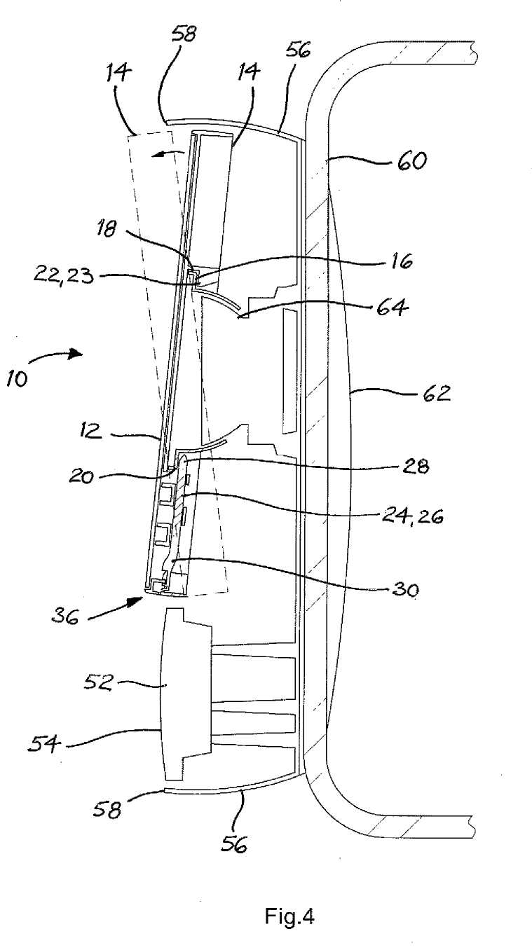

As shown in FIGS. 3 to 11, the rear of the top mirror 12 is attached to a first surface of the mirror plate 14. An opposite second surface of the mirror plate 14 has an attachment arrangement for releasably engaging the mirror plate 14 to the mirror retention plate 16. In this embodiment, the mirror retention plate 16 is connected to an electric motorized actuator 64 for adjusting the angular position of the mirror plate 14, and hence the angular position of the top mirror 12, as particularly shown in FIG. 4.

The first edge 18 of the mirror retention plate 16 engages the two projections 22, 23 of the mirror plate 14 so that the mirror plate assumes the engaged position. The second edge 20 which, in this embodiment, is parallel and opposite to the first edge 18 of the mirror retention plate 16, is engaged by a locking assembly that includes the two locking pins 24, 26 which are each slidably movable between a locking position and an unlocking position. With the mirror plate 14 in the engaged position, moving the locking pins 24, 26 to the locking position allows the mirror plate 14 to assume the locked position.

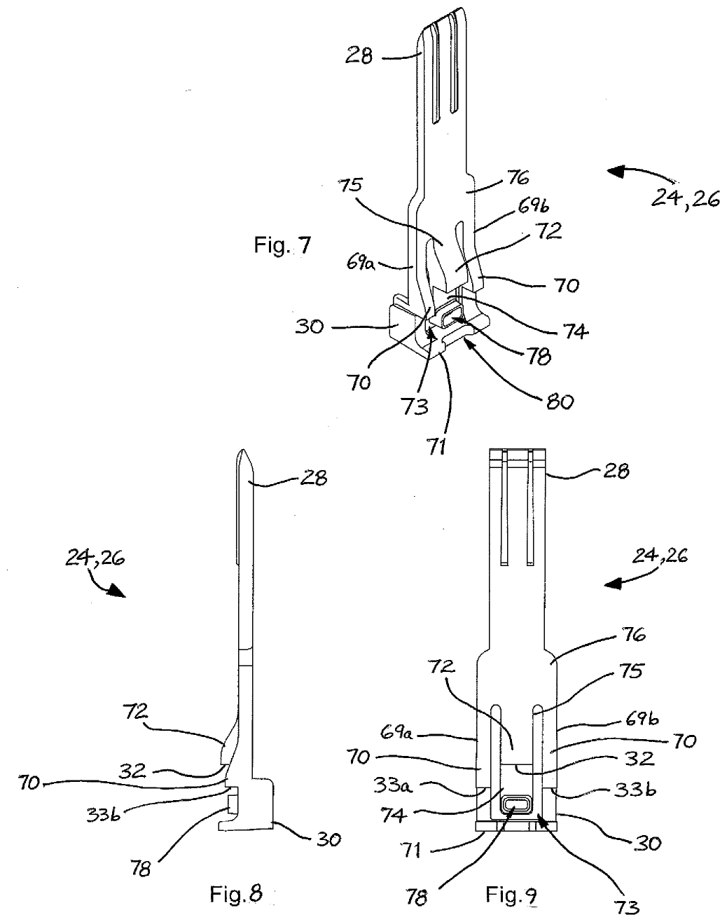

As best shown in FIGS. 7 to 21, the leading free end 28 of each locking pin 24, 26 is configured to be inserted through a respective side wall opening 65a, 65b of the mirror plate 14 and then through respective aligned openings defined by internal bridges 66, 67a, 67b formed on the mirror plate 14. Each leading free end 28 can penetrate only as far as a particular overlapping location with the second edge 20 of the mirror retention plate 16, before the locking pin 24, 26 is prevented from further penetration by one or more structural elements of the head end 30 abutting against one or more walls of the mirror plate 14. With the leading free ends 28 at that overlapping location, the most outwardly located end walls of the head ends 30 of the locking pins 24, 26 are at a location where they are aligned with a surrounding side wall 68 of the mirror plate 14.

The spring loaded clip-on mechanism 36, which is operable to engage one or more pin locking surfaces of each locking pin 24, 26 with a respective plate locking surface of the mirror plate 14, is located at the head end 30 of each locking pin.

Referring specifically to FIGS. 7 to 10, each head end 30 of the locking pins 24, 26 includes an inner pin locking surface 32 and a pair of outer pin locking surfaces 33a, 33b at respective opposite sides 69a, 69b of the head end 30.

The outer pin locking surfaces 33a, 33b are, in this embodiment, the elevated end face surfaces of side ramped structures 70 which are formed at the opposite sides 69a, 69b of the head end 30 of each locking pin 24, 26. The opposite sides 69a, 69b of the head end 30 are separated by a gap 73 and are flexible, and are interconnected by an end wall 71. The end wall 71 has a cut-out edge portion 80.

The inner pin locking surface 32 is, in this embodiment, the elevated end face surface of a central ramped structure 72 which is formed on a flexible tongue portion 74 of the head end 30 of each locking pin 24, 26. The tongue portion 74 extends into the gap 73 separating the opposite sides 69a, 69b of the head end 30. The tongue portion 74 has a connecting end 75 at which it is connected to a main body 76 of the locking pin 24, 26, and has a free end at which a receptacle 78 is located.

The central ramped structure 72 is located intermediate the connecting end 75 of the tongue portion 74 and the receptacle 78.

The inner pin locking surface 32 of the central ramped structure 72 of the tongue portion 74 is located further from the end wall 71 than are the outer pin locking surfaces 33a, 33b of the side ramped structures 70 at the opposite sides 69a, 69b of the head end 30.

Also, the height of the inner pin locking surface 32 of the central ramped structure 72 is greater than the height of the outer pin locking surfaces 33a, 33b of the side ramped structures 70.

Each plate locking surface 34 of the mirror plate 14 is, in this embodiment, an inner surface of a plate locking wall 79 located internally of, and extending partly across, the side wall opening 65a, 65b of the mirror plate 14.

The outer pin locking surfaces 33a, 33b of the flexible opposite sides 69a, 69b and the inner pin locking surface 32 of the flexible tongue portion 74 at the head end 30 of each of the locking pins 24, 26, and the respective plate locking surface 34 against which the inner and outer pin locking surfaces 32, 33a, 33b can be engaged, are preferred parts of the spring loaded clip-on mechanism, the operation of which will be described in more detail later in this specification.

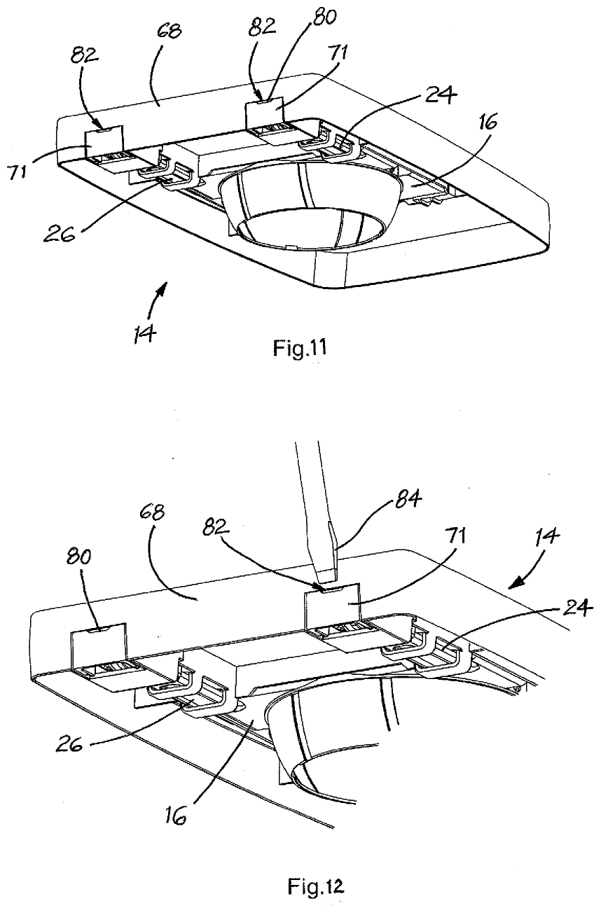

Referring specifically to FIGS. 11 and 12, the cut-out edge portion 80 (as also shown in FIG. 7) of the end wall 71 of the head end 30 of each locking pin 24, 26 is formed such that, when the locking pin 24, 26 is inserted to its locking position, the cut-out edge portion 80 creates a small opening 82 in the side wall 68 of the mirror plate 14 for receiving therethrough the tip 84 of a screwdriver or similar tool to begin an unlocking process. In such an unlocking process, the locking pins 24, 26 are slidably moved from a locking position with respect to the mirror retention plate 16 to an unlocking position where the mirror plate 14 can be disengaged from the mirror retention plate 16.

FIGS. 12 to 21 show detail of a two stage unlocking process, which utilizes the locking pins 24, 26.

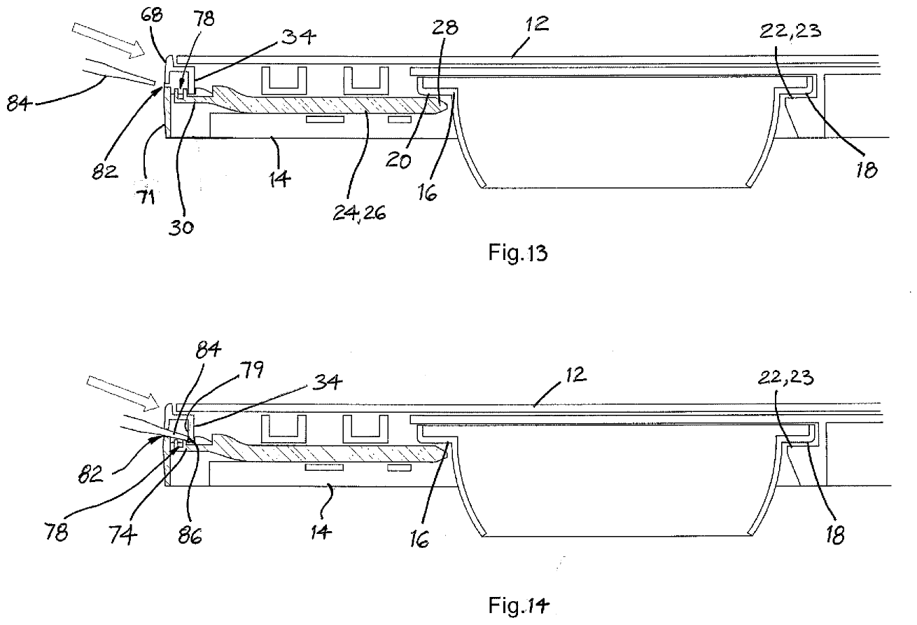

Specifically, FIGS. 12 and 13 show the tip 84 of a screwdriver, which is held by a user, being advanced towards the small opening 82 in the side wall 68 of the mirror plate 14.

FIG. 14 shows the tip 84 inserted tightly through the small opening 82, and the leading edge 86 of the tip 84 pressed against both the tongue portion 74 and the plate locking wall 79 of the mirror plate 14. Alternatively, the leading edge 86 of the tip 84 may be pressed against the floor of the receptacle 78 of the tongue portion 74.

As shown in FIG. 15, the user applies downward force through the tip 84 and at the same time pivots the handle end of the screwdriver upwardly towards and against the adjacent side wall 68 of the mirror plate 14, thereby using the screwdriver as a lever, with the “effort” being the sum of the applied forces of the tip 84 being pressed against the tongue portion 74 and the tip 84 being pivoted against the side wall 68, the fulcrum being the side wall 68, and the “load” being the sum of the opposing force from the tongue portion 74 against the tip 84 and the force of the resistance to movement of the locking pin 24, 26.

The head end 30 of the locking pin 24, 26 is flexibly distorted sufficiently by this “press down and lever out” action to allow the side ramped structures 70, which are of a lower height than the central ramped structure 72, to no longer have their elevated end face surfaces (i.e. the outer pin locking surfaces 33a, 33b) engage against the plate locking surface 34 of the mirror plate 14 and to therefore slide underneath the plate locking surface 34. This initial outward sliding motion of the locking pin 24, 26 is stopped when the elevated end face surface (i.e. the inner pin locking surface 32) of the taller central ramped structure 72 engages against the plate locking surface 34 of the mirror plate 14. This position is shown in FIG. 16. At this position, the leading free end 28 of the locking pin 24, 26 still sufficiently engages the second free edge 20 of the mirror retention plate 16 to lockably retain the mirror plate 14 in the locked position.

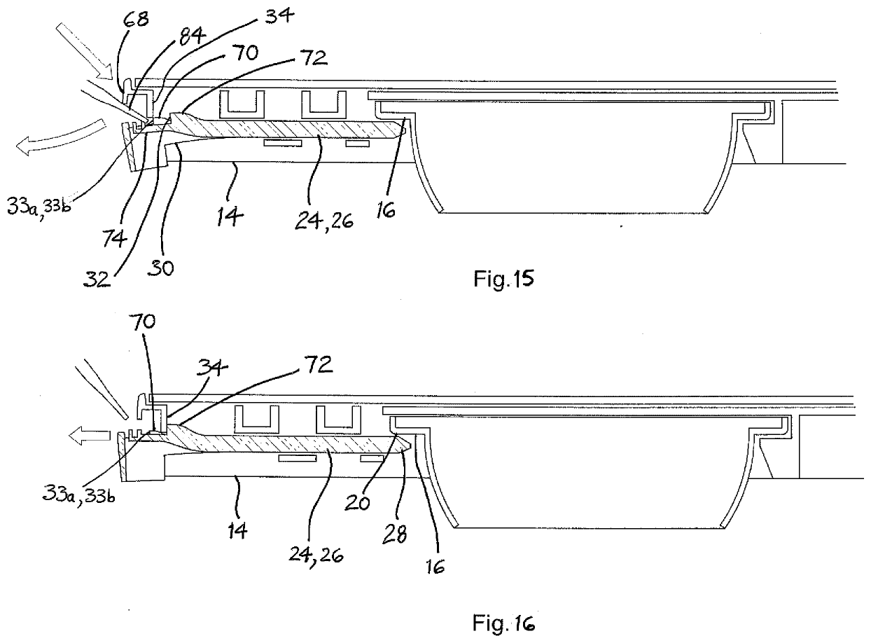

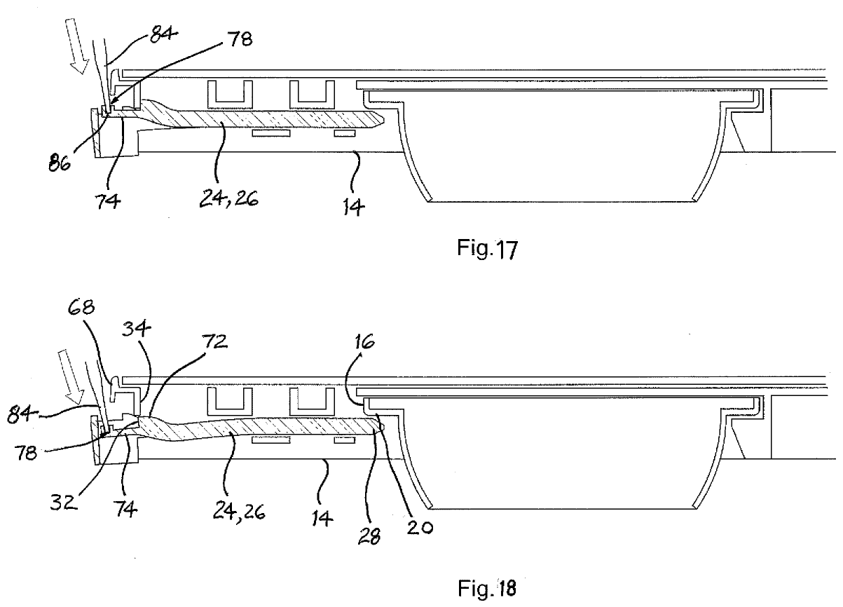

The tip 84 of the screwdriver is then repositioned to begin the second stage of this unlocking process, as shown in FIG. 17, so that its leading edge 86 is received in the receptacle 78 of the tongue portion 74.

The tip 84 is then pressed downwardly against the floor of the receptacle 78, as shown in FIG. 18, to flexibly distort the tongue portion 74 of the locking pin 24, 26 sufficiently to allow the central ramped structure 72 to no longer have its elevated end face surface (i.e. the inner pin locking surface 32) engage against the plate locking surface 34 of the mirror plate 14. The screwdriver may again be used as a lever, with the side wall 68 of the mirror plate 14 being the fulcrum, in a similar manner to the “press down and lever out” action mentioned earlier, so that the central ramped structure 72 can slide underneath the plate locking surface 34.

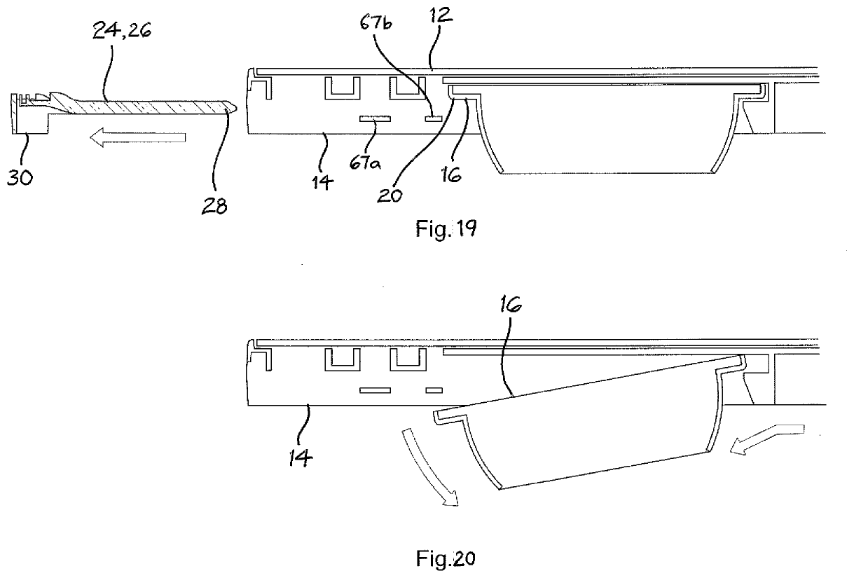

As the central ramped structure 72 is sliding underneath the plate locking surface 34, the leading free end 28 of the locking pin 24, 26 disengages the second edge 20 of the mirror retention plate 16 and assumes the unlocking position, whereby the spring loaded clip-on mechanism has been released. This final outward sliding motion of the locking pin 24, 26 is maintained until the leading free end 28 emerges from the last of the internal bridges 66, 67a, 67b of the mirror plate 14. This position is shown in FIG. 19.

As shown in FIGS. 20 and 21, the mirror plate 14 can then be disengaged from the mirror retention plate 16.

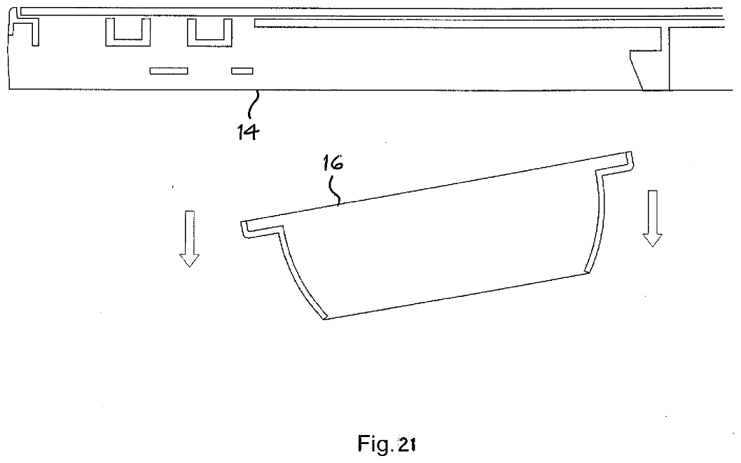

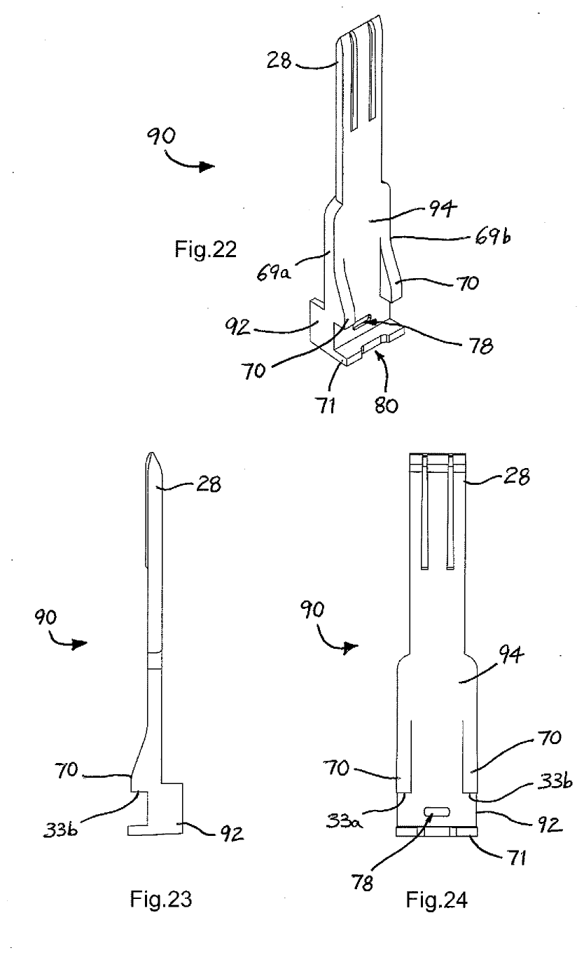

An alternative embodiment of locking pin 90 is shown in FIGS. 22 to 24. It is identical to locking pin 24, 26 except that it has no gap between the opposite sides of its head end 92, and therefore there is no flexible tongue portion. Like features are identified by like numerals in the following description.

The locking pin 90 does, however, have a receptacle 78 formed in a flexible main body portion 94 at its head end 92 adjacent to the end wall 71. The head end 92 of the locking pin 90 also has a pair of outer pin locking surfaces 33a, 33b which are, in this embodiment, the elevated end face surfaces of side ramped structures 70 formed at opposite sides 69a, 69b of the head end 92. The opposite sides of the head end 92 are flexible and are interconnected by an end wall 71 having a cut-out edge portion 80.

Two locking pins 90 are used in a single stage unlocking process which involves only the outer pin locking surfaces 33a, 33b of the flexible opposite sides at the head end 92 of each of the locking pins 90, and the respective plate locking surface 34 against which the outer pin locking surfaces 33a, 33b can be engaged. These are preferred parts of an alternative spring loaded clip-on mechanism, the operation of which will now be described in more detail.

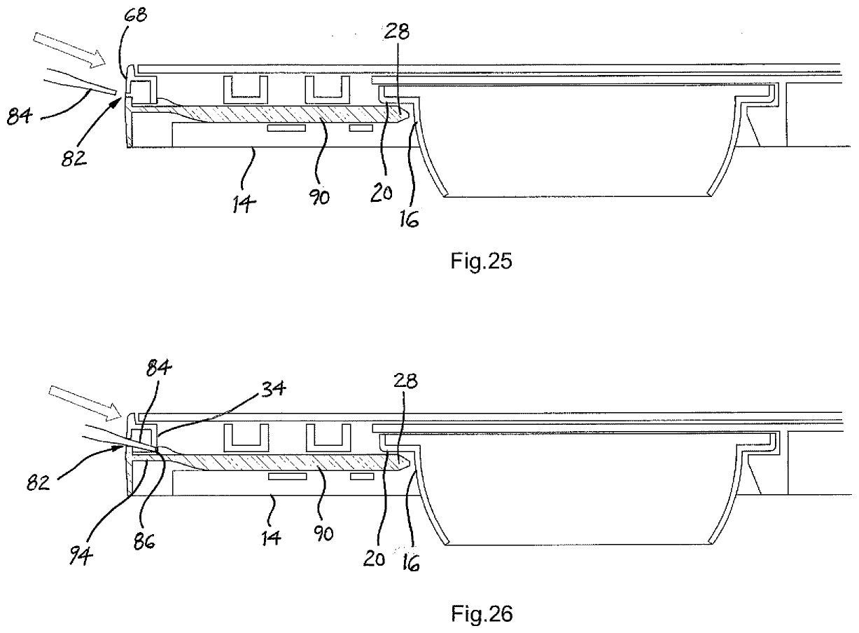

FIGS. 25 to 30 show detail of the single stage unlocking process, which utilizes two of the locking pins 90.

Specifically, FIG. 25 shows the tip 84 of a screwdriver, which is held by a user, being advanced towards the small opening 82 in the side wall 68 of the mirror plate 14.

FIG. 26 shows the tip 84 inserted tightly through the small opening 82, and the leading edge 86 of the tip 84 pressed against the flexible main body portion 94 at the head end 92 of the locking pin 90 and underneath the plate locking surface 34 of the mirror plate 14. Alternatively, the leading edge 86 of the tip 84 may be pressed against the floor of the receptacle 78 of the flexible main body portion 94.

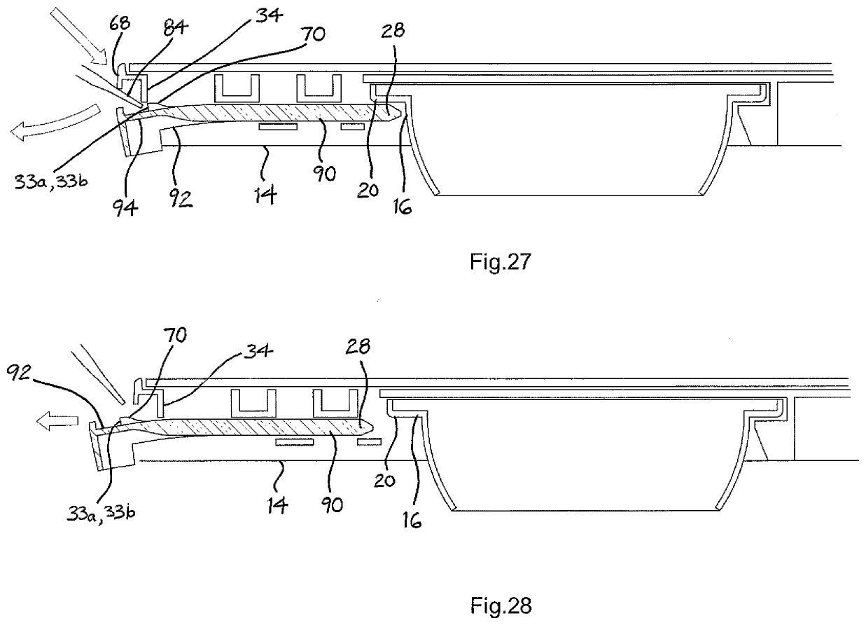

The screwdriver is then used as a lever, as shown in FIG. 27, with the user, while continuing to apply downward force through the tip 84, pivoting the handle end of the screwdriver upwardly towards and against the adjacent side wall 68 of the mirror plate 14.

As shown in FIG. 28, the head end 92 of the locking pin 90 is flexibly distorted sufficiently by this “press down and lever out” action to allow the side ramped structures 70 to no longer have their elevated end face surfaces (i.e. the outer pin locking surfaces 33a, 33b) engage against the plate locking surface 34 of the mirror plate 14 so that the side ramped structures 70 can slide underneath the plate locking surface 34.

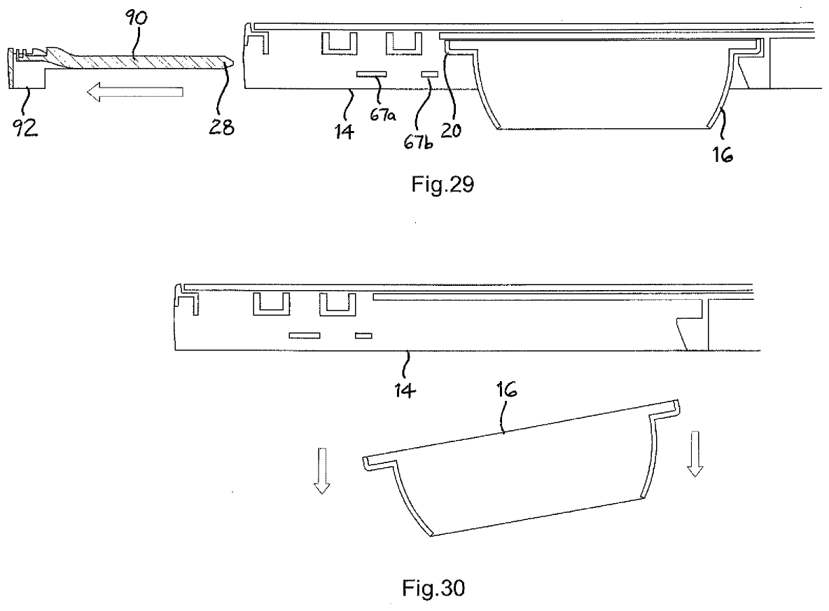

As the side ramped structures 70 are sliding underneath the plate locking surface 34, the leading free end 28 of the locking pin 90 disengages the second edge 20 of the mirror retention plate 16 and assumes the unlocking position, whereby the spring loaded clip-on mechanism has been released. This outward sliding motion of the locking pin 90 is maintained by the user continuing to employ the screwdriver in the “press down and lever out” action, until the leading free end 28 emerges from the last of the internal bridges 66, 67a, 67b of the mirror plate 14. This position is shown in FIG. 29.

As shown in FIG. 30, the mirror plate 14 can then be disengaged from the mirror retention plate 16.

As would be apparent from the single stage unlocking process described above, because only the outer pin locking surfaces 33a, 33b of each of the locking pins 90 can engage the respective plate locking surface 34 of the mirror plate 14, only a single “press down and lever out” action is required to cause the outward sliding motion of each of the locking pins 90 for the purpose of releasing the spring loaded clip-on mechanism to disengage the mirror plate 14 from the mirror retention plate 16. This is in contrast to the two stage “press down and lever out” action required for the purpose of releasing the spring loaded clip-on mechanism that uses the locking pins 24, 26.

As would be understood by a person skilled in the art, the side ramped structures 70 can alternatively be one ramped structure that extends across the locking pin or be a centrally located central ramped structure.

It would also be apparent to a person skilled in the art that the locking pin 24, 26 contributes to a more secure and reliable locking assembly for the external vehicle rear view mirror assembly 10, 11, than the locking pin 90. However, the locking pin 90 may still be useful in circumstances where security and reliability are not of paramount importance, or where the mirror assembly has other means for ensuring a secure and reliable locking arrangement, but where ease of unlocking may be important.

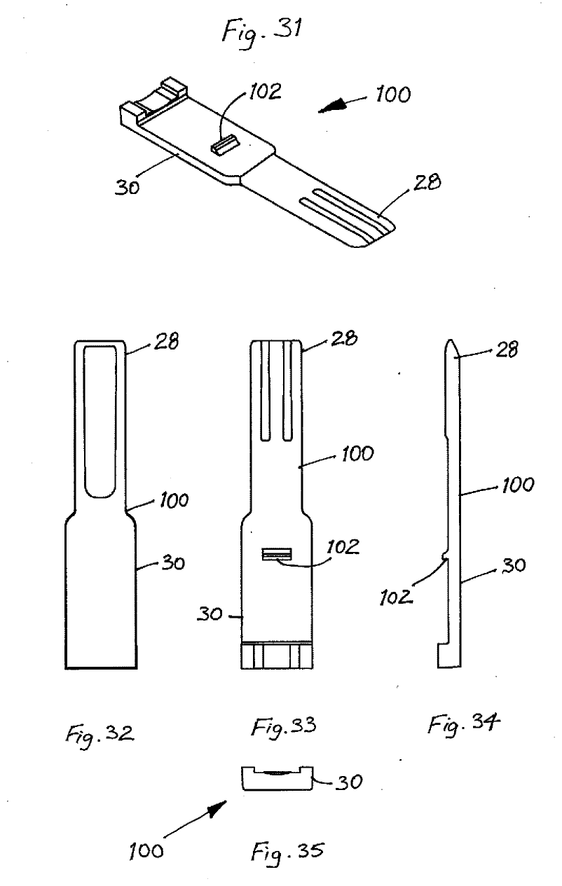

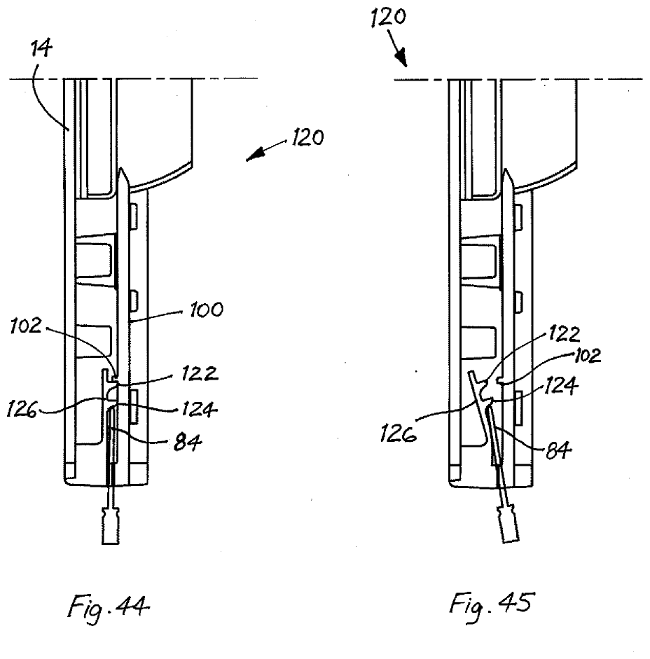

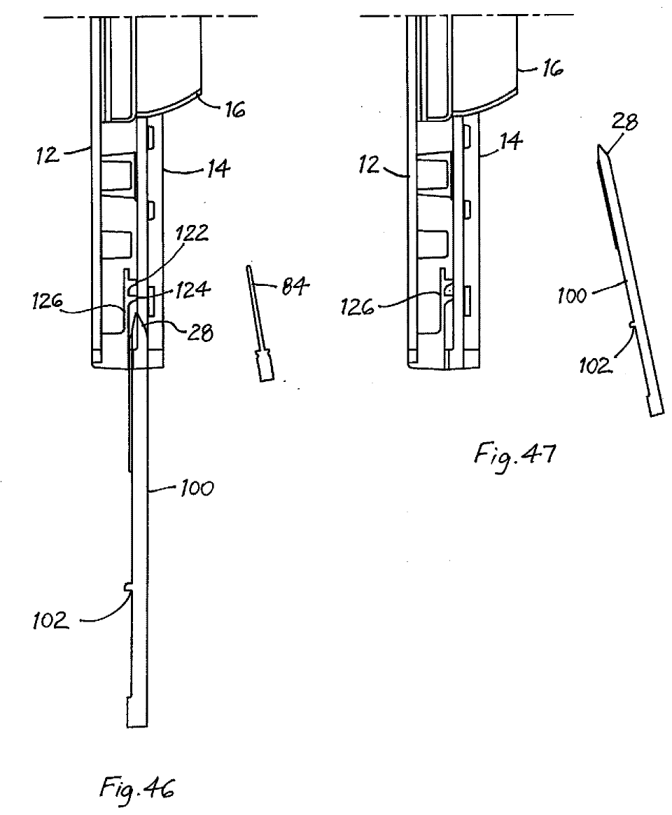

Persons skilled in the art would also appreciate that the inventive concept underpinning the above described embodiments of the invention may also be embodied by a reversal of the structural arrangement of the above mentioned spring loaded clip-on mechanism (as shown in FIGS. 31 to 55).

To achieve such a structural reversal, the spring loaded clip-on mechanism may instead broadly comprise a plate locking surface of a flexible tongue portion of the mirror plate, and a pin locking surface at the head end of the locking pin and against which the plate locking surface can be engaged.

A more particular embodiment which is also a reversal of the structural arrangement of the spring loaded clip-on mechanism described with reference to FIGS. 1 to 30, may comprise outer plate locking surfaces of flexible opposite sides of a part of the mirror plate, an inner plate locking surface of a flexible tongue portion of the same part of the mirror plate, and respective pin locking surfaces at the head end of the or each locking pin and against which the outer and inner plate locking surfaces can be engaged.

In order to more easily understand such an alternative embodiment, like numerals will be used in FIGS. 31 to 47 to identify like features earlier described with reference to FIGS. 1 to 30. For such like features in FIGS. 31 to 47, the details of their structure and function can also be understood from the relevant drawings and description with reference to FIGS. 1 to 30.

FIGS. 31 to 35 show a locking pin 100 having a leading free end 28 and an opposite head end 30. The head end 30 has a pin locking surface 102.

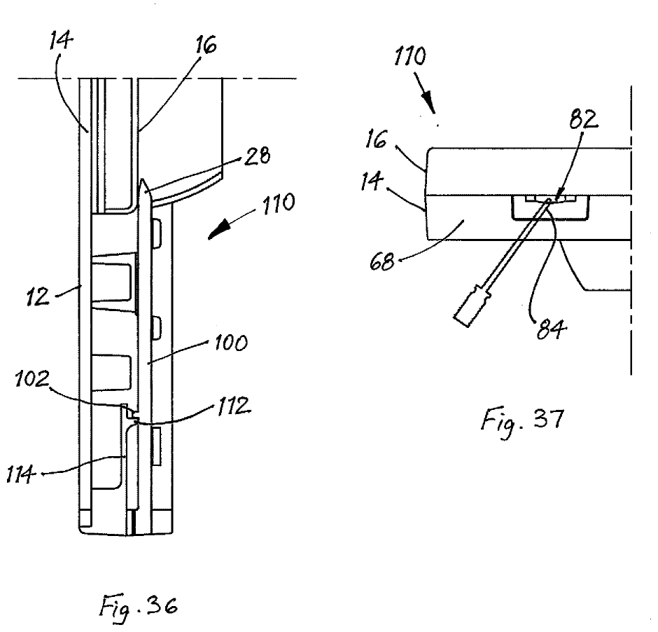

FIG. 36 shows a top mirror assembly 110 having a plate locking surface 112 of a flexible tongue portion 114. The plate locking surface 112 is engaged against the pin locking surface 102 of the locking pin 100.

FIG. 37 shows a tip 84 of a screwdriver being advanced towards a small opening 82 in the side wall 68 of the mirror plate 14 to begin the unlocking process.

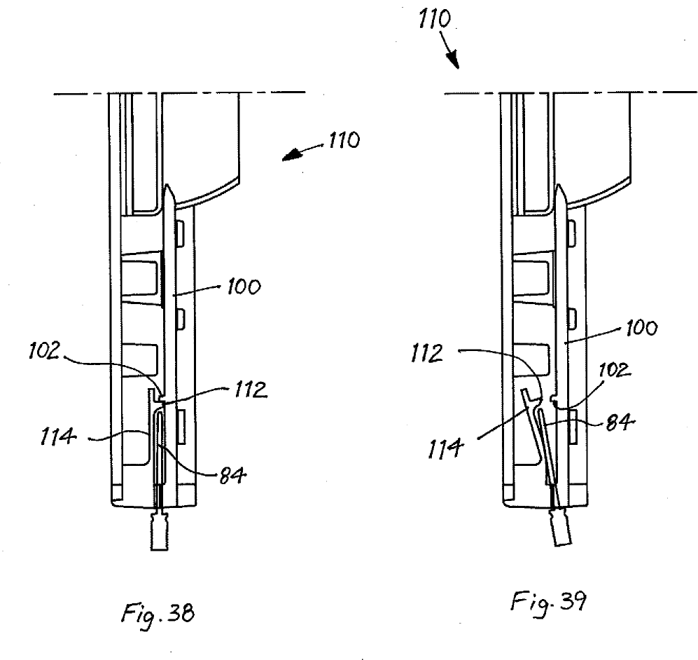

FIG. 38 shows the screwdriver inserted through the small opening 82, and the leading edge of the tip 84 about to be pressed against the plate locking surface 112 of the flexible tongue portion 114 of the top mirror assembly 110.

As shown in FIG. 39, the user uses the screwdriver to apply force against the plate locking surface 112 and at the same time pivots the screwdriver so as to cause the flexible tongue portion 114 of the top mirror assembly 110 to be flexibly distorted sufficiently to allow the plate locking surface 112 to disengage from the pin locking surface 102 of the locking pin 100.

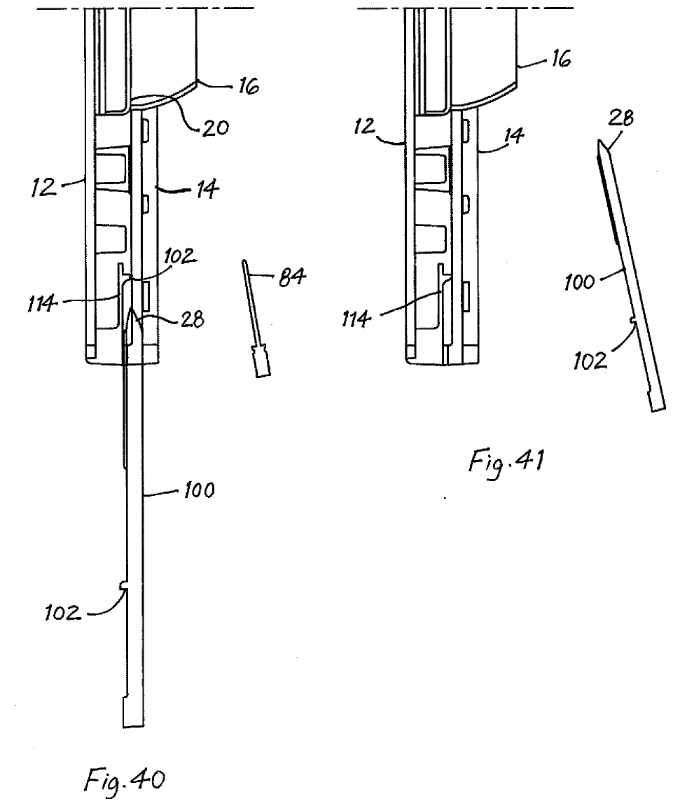

With the plate locking surface 112 disengaged from the pin locking surface 102, the locking pin 100 can be slid outwardly from the top mirror assembly 110, as shown in FIG. 40.

During this outward sliding motion of the locking pin 100, the free end 28 of the locking pin 100 disengages the second edge 20 of the mirror retention plate 16 and assumes the unlocking position, whereby the spring loaded clip-on mechanism has been released. The mirror plate 14 can then be disengaged from the mirror retention plate 16.

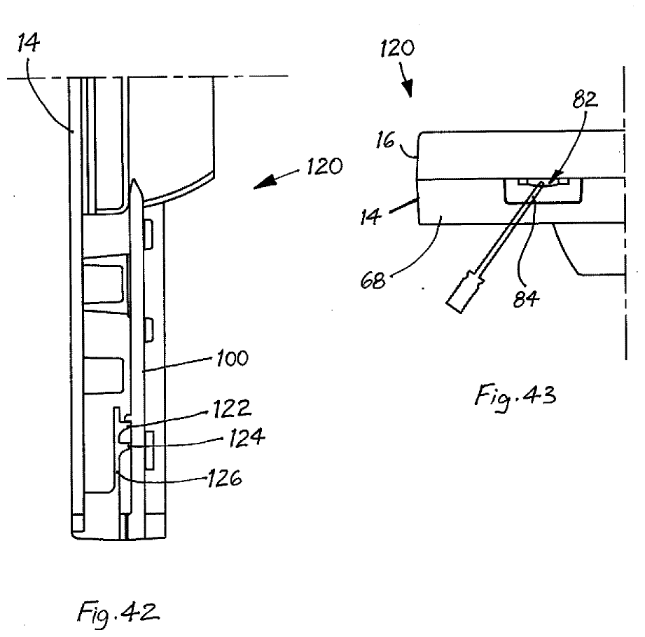

FIG. 41 shows the top mirror assembly 110 after the locking pin 100 has been fully released therefrom.

FIGS. 42 to 47 show the same process as shown in FIGS. 36 to 41, but this process instead uses a top mirror assembly 120 having two plate locking surfaces 122, 124 of a flexible tongue portion 126. The plate locking surfaces 122, 124 are engaged against respective pin locking surfaces of the locking pin 100. The process steps are essentially the same as described with reference to FIGS. 37 to 41.

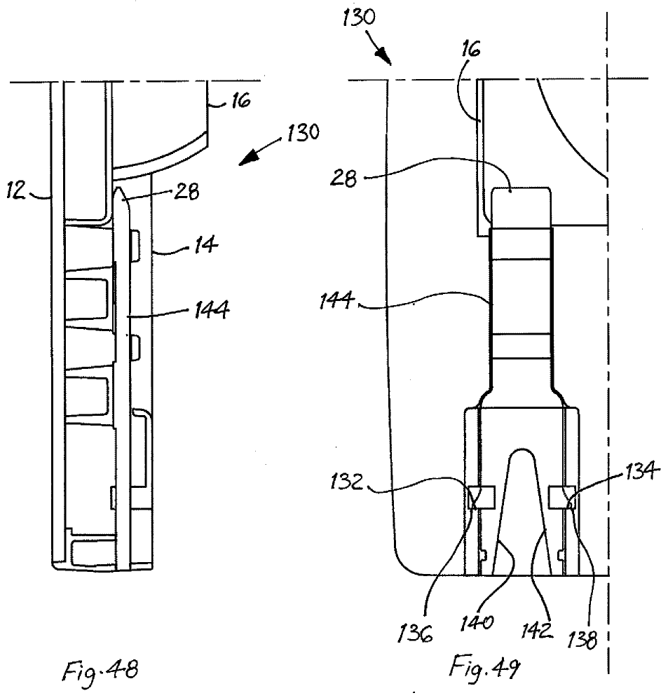

Another embodiment of the present invention, but not one embodying a reversal of the structural arrangement of the spring loaded clip-on mechanism, is described below with reference to FIGS. 48 to 55.

FIGS. 48 and 49 show a top mirror assembly 130 having a pair of plate locking surfaces 132, 134. The plate locking surfaces 132, 134 are engaged against a pair of respective pin locking surfaces 136, 138 of respective flexible tongue portions 140, 142 at opposite sides of the locking pin 144.

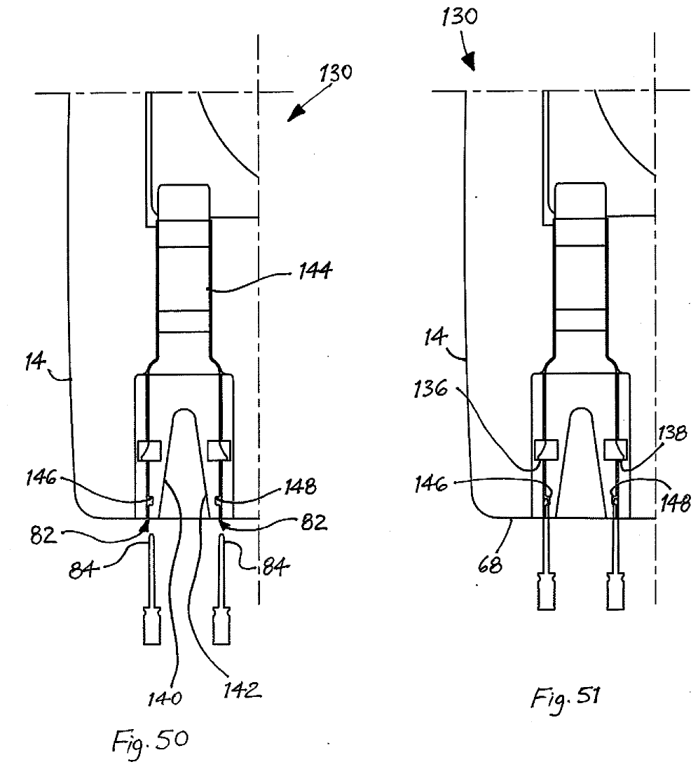

FIG. 50 shows the tips 84 of a pair of screwdrivers being advanced towards respective small openings 82 in the side wall 68 of the mirror plate 14 to begin the unlocking process.

FIG. 51 shows both of the screwdrivers inserted through the respective small openings 82, and the leading edges of the tips 84 about to be pressed against respective receptacles 146, 148 which are located in respective flexible tongue portions 140, 142 of the locking pin 144. The pin locking surfaces 136, 138 are located inwardly of the respective receptacles 146, 148 along the flexible tongue portions 140, 142.

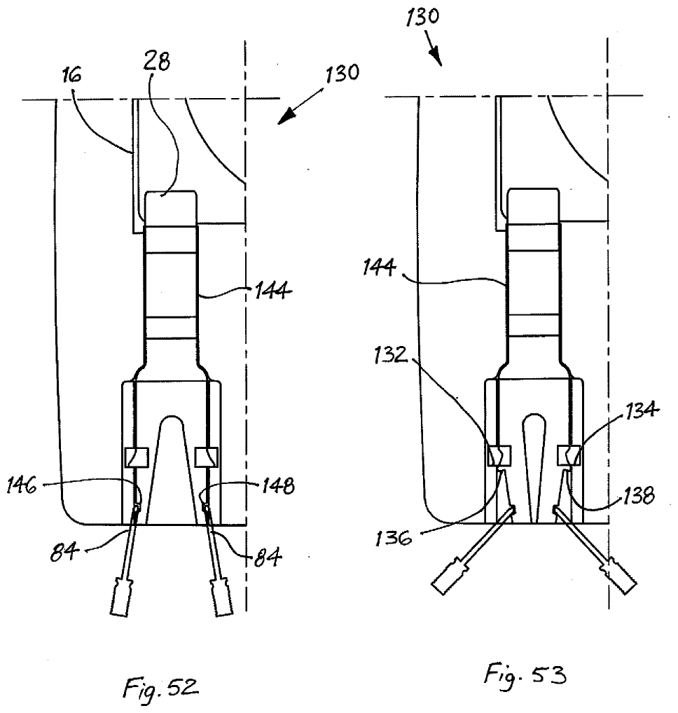

As shown in FIGS. 52 and 53, the user uses the screwdrivers to apply force against the receptacles 146, 148 and at the same time pivots the screwdrivers so as to cause the flexible tongue portions 140, 142 of the locking pin 144 to be flexibly distorted sufficiently to allow the pin locking surfaces 136, 138 to disengage from the plate locking surfaces 132, 134 of the top mirror assembly 130.

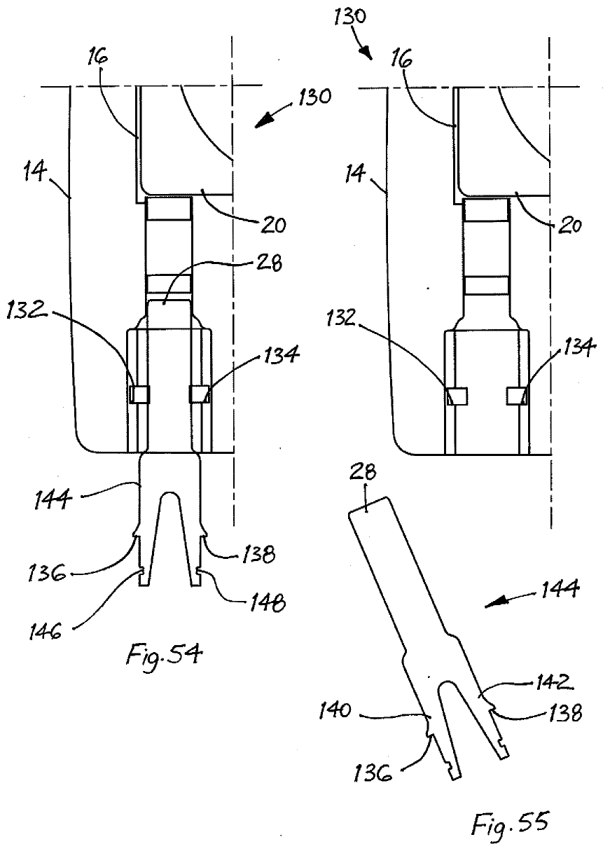

With the pin locking surfaces 136, 138 disengaged from the plate locking surfaces 132, 134, the locking pin 144 can be slid outwardly from the top mirror assembly 130, as shown in FIG. 54.

During this outward sliding motion of the locking pin 144, the free end 28 of the locking pin 144 disengages the second edge 20 of the mirror retention plate 16 and assumes the unlocking position, whereby the spring loaded clip-on mechanism has been released. The mirror plate 14 can then be disengaged from the mirror retention plate 16.

FIG. 55 shows the top mirror assembly 130 after the locking pin 144 has been fully released therefrom.

The above embodiment may include a second pair of plate locking surfaces (such as an elongated slot or wall surface in the mirror plate) for use as a fail-safe against accidental disengagement of the pin locking surfaces from the plate locking surfaces, such as may be caused by excessive vibration of the mounted mirror assembly.

As would also be apparent from the above description of all of the embodiments of the present invention, the external vehicle rear view mirror assembly of the present invention includes a locking and release assembly for a mirror plate which provides for both easy locking and easy releasing of the mirror plate, so as to facilitate easy replacement of the mirror plate when required.

The external vehicle rear view mirror assembly of the present invention described above also provides a locking assembly for a mirror plate in such mirror assemblies which can securely and reliably lock the mirror plate in its operational position and which can then be easily released by simple “press down and lever out” actions of a user utilizing a screwdriver or the like.

It will be readily appreciated by persons skilled in this art, upon reading this description of embodiments of the invention, that there may be alternative embodiments of the external vehicle rear view mirror assembly which do not depart from the scope or ambit of the present invention.

The reference in this specification to any prior publication (or information derived from it), or to any matter which is known, is not, and should not be taken as an acknowledgement or admission or any form of suggestion that that prior publication (or information derived from it) or known matter forms part of the common general knowledge in the field of endeavour to which this specification relates before the filing date of this patent application.

1. An external vehicle rear view mirror assembly, comprising: a mirror, a mirror plate having a first surface to which the mirror is attached and a second surface being opposite to the first surface, the second surface having an attachment arrangement for releasably engaging the mirror plate to a mirror retention plate, the mirror retention plate having a first edge and a second edge, the attachment arrangement comprising one or more projections of the mirror plate for engaging the first edge of the mirror retention plate so that the mirror plate can assume an engaged position with respect to the mirror retention plate, and a locking assembly for engaging the second edge of the mirror retention plate so that the mirror plate, when in the engaged position, can assume a locked position with respect to the mirror retention plate, the locking assembly comprising at least one slidable locking pin movable between a locking position and an unlocking position, the or each locking pin having a leading free end and an opposite head end, the head end having at least one pin locking surface which is engageable with a plate locking surface of the mirror plate by operation of a spring loaded clip-on mechanism, wherein, when the or each locking pin is in the locking position, the leading free end of the or each locking pin has engaged the second edge of the mirror retention plate and lockably retained the mirror plate in the locked position, and when the or each locking pin is in the unlocking position, the leading free end of the or each locking pin has disengaged from the second edge of the mirror retention plate after releasing the spring loaded clip-on mechanism.

2. The assembly of claim 1 wherein there are two locking pins in the mirror assembly.

3. The assembly of claim 1 wherein the spring loaded clip-on mechanism is located at the head end of the or each locking pin.

4. The assembly of claim 1, wherein the head end of the or each locking pin has from one to three pin locking surfaces which are engageable with a respective plate locking surface of the mirror plate by operation of the spring loaded clip-on mechanism.

5. The assembly of claim 4 wherein the head end of the or each locking pin has three pin locking surfaces.

6. The assembly of claim 1, wherein the plate locking surface of the mirror plate is an inner surface of a locking wall located internally of, and extending partly across, an opening in a side wall of the mirror plate.

7. The assembly of claim 1, wherein the mirror retention plate is connected to an electric motorized actuator for adjusting the angular position of the mirror.

8. The assembly of claim 1, wherein the first and second edges of the mirror retention plate are parallel to each other.

9. The assembly of claim 1, wherein there are two projections of the mirror plate for engaging the first edge of the mirror retention plate.

10. The assembly of claim 6 wherein the leading free end of the or each locking pin is configured to be inserted through the opening in the side wall of the mirror plate and then through aligned openings defined by internal bridges formed on the mirror plate.

11. The assembly of claim 1, wherein the leading free end of the or each locking pin can penetrate only as far as an overlapping location with the second edge of the mirror retention plate, before the locking pin is prevented from further penetration by one or more structural elements of the head end abutting against one or more walls of the mirror plate.

12. The assembly of claim 11 wherein, when the leading free end is at the overlapping location, the most outwardly located end wall of the head end of the or each locking pin is at a location where it is aligned with a side wall of the mirror plate.

13. The assembly of claim 1, wherein the head end of the or each locking pin includes an inner pin locking surface and a pair of outer pin locking surfaces at respective opposite sides of the head end.

14. The assembly of claim 13 wherein the outer pin locking surfaces are the elevated end face surfaces of side ramped structures which are formed at opposite sides of the head end of the or each locking pin.

15. The assembly of claim 14 wherein the opposite sides of the head end are separated by a gap and are flexible, and are interconnected by an end wall.

16. The assembly of claim 15 wherein the inner pin locking surface is the elevated end face surface of a central ramped structure which is formed on a flexible tongue portion of the head end of the or each locking pin.

17. The assembly of claim 16 wherein the flexible tongue portion extends into the gap separating the opposite sides of the head end.

18. The assembly of claim 17 wherein the flexible tongue portion has a connecting end at which it is connected to a main body of the or each locking pin, and has a free end at which a receptacle is located.

19. The assembly of claim 18 wherein the central ramped structure is located intermediate the connecting end of the flexible tongue portion and the receptacle.

20. The assembly of claim 16 wherein the inner pin locking surface of the central ramped structure of the flexible tongue portion is located further from the end wall than are the outer pin locking surfaces of the side ramped structures at the opposite sides of the head end.

21. The assembly of claim 16 wherein a height of the inner pin locking surface of the central ramped structure is greater than a height of the outer pin locking surfaces of the side ramped structures.

22. The assembly of claim 1 wherein the spring loaded clip-on mechanism comprises a pin locking surface at the head end of the or each locking pin, and a plate locking surface of the mirror plate and against which the pin locking surface can be engaged.

23. The assembly of claim 1 wherein the spring loaded clip-on mechanism comprises outer pin locking surfaces of flexible opposite sides at the head end of the or each locking pin, an inner pin locking surface of a flexible tongue portion at the head end of the or each locking pin, and respective plate locking surfaces of the mirror plate and against which the outer and inner pin locking surfaces can be engaged.

24. The assembly of claim 1 wherein the spring loaded clip-on mechanism comprises a plate locking surface of a flexible tongue portion of the mirror plate, and a pin locking surface at the head end of the locking pin and against which the plate locking surface can be engaged.
